(19) United States
(12) Patent Application Publication
(10) Pub. No.: US 2016/0342731 A1
(43) Pub. Date: Nov. 24, 2016

(54) SYSTEM IDENTIFICATION DEVICE

(71) Applicant: MITSUBISHI ELECTRIC CORPORATION, Chiyoda-ku (JP)

(72) Inventors: Mitsunori SAITO, Tokyo (JP); Yurika KANAI, Tokyo (JP)

(73) Assignee: Mitsubishi Electric Corporation, Chiyoda-ku, (JP)

(21) Appl. No.: 15/114,729

(22) PCT Filed: Nov. 4, 2014
(86) PCT No.: PCT/JP2014/079257

§ 371 Date: Jul. 27, 2016

(30) Foreign Application Priority Data
Feb. 7, 2014 (JP) 2014-022814

(51) Int. Cl. G06F 17/50

(52) U.S. Cl. CPC G06F 17/5086

(57) ABSTRACT

A system identification device identifies a linear discrete-time system using a recursive method with respect to each dimension belonging to a designated search range of a system dimension, calculates a system output obtained when actual input data for identification is applied to a linear discrete-time system corresponding to each dimension as a system characteristic, determines a minimum dimension from among dimensions at which a norm distribution of sum of squares of errors in a time domain of the system output and actual output data for identification of the dynamic system is less than or equal to a threshold value, to be a system dimension n, and identifies a system matrix of the linear discrete-time system based on input and output vectors of the dynamic system, and a state vector generated using the determined system dimension.

### FIELD

The present invention relates to a system identification device for constructing a mathematical model of a target dynamic system based on an input and an output of the system obtained when a pseudorandom input is applied to the system.

### BACKGROUND

For example, a system identification device based on an N4SID method disclosed in Non Patent Literature 1 has been proposed as a conventional system identification device based on a pseudorandom input. In this N4SID method, block Hankel matrices (Uₚ, U_{f}) related to a system input and block Hankel matrices (Yₚ, Y_{f}) related to a system output are generated based on the system input and output which are obtained when a pseudorandom input is applied to a dynamic system described in a linear discrete-time system (A_{d}, B_{d}, C_{d}, D_{d}) , and input and output vectors (^{˜}U_{K|K}, ^{˜}Y_{K|K}) are generated based on the block Hankel matrices (Uₜ, Y_{f}). Referring to a notation of “^{˜}”, a horizontal line (overbar) should be drawn over a letter of “U”, essentially, the notation of the latter cannot be realized. To this end, in this specification, the horizontal line (overbar) is replaced by “^{˜}” except for parts of numerical formulas inserted by image.

Subsequently, a data matrix, which is obtained by combining the above-mentioned block Hankel matrices, is LQ-decomposited, and a parallel projection Θ is generated from a submatrix which is obtained by the LQ decomposition and the block Hankei matrices Uₚ, Yₚ. Singular value decomposition is applied to the parallel projection Θ to determine the number of singular values having significant values to be a system dimension, and state vectors (^{˜}X_{K}, ^{˜}X_{K+1}) of the dynamic system is calculated from a result of the singular value decomposition and the determined system dimension. Finally, the linear discrete-time system (A_{d}, B_{d}, C_{d}, D_{d}) that describes the dynamic system is identified by applying a method of least square to the input and output vectors (^{˜}U_{K|K}, ^{˜}Y_{K|K}) and the state vectors (^{˜}X_{K}, ^{˜}X₊₁).

In addition, for example, an exposure apparatus and an anti-vibration apparatus, a system identification apparatus and a method therefor disclosed in Patent Literature 1 have been proposed as other examples of the conventional system identification device based on the pseudorandom input.

In the exposure apparatus and the anti-vibration apparatus, the system identification apparatus and its method, a state equation of a target dynamic system is identified using a subspace method typified by the NISID method based on system input and output which are obtained when a pseudorandom input is applied to the target dynamic system. In this instance, by making a system dimension of the identified state equation equal to a system dimension determined from an equation of motion of the dynamic system, an unknown physical parameter included in the equation of motion is identified on the basis of a comparison between a characteristic equation based on the equation of motion and another characteristic equation based on the identified state equation.

### CITATION LIST

### Patent Literature

Patent Literature 1: Japanese Patent Application

Laid-Open No. 2000-82662

### Non Patent Literature

Non Patent Literature 1: “SYSTEM IDENTIFICATION—APPROACH FROM SUBSPACE METHOD—”, Asakura Publishing Co., Ltd., pp. 117-120

### SUMMARY

### Technical Problem

Such a pseudorandom-input-based system identification device determines a system dimension of a target dynamic system from the number of singular values having significant values or a system dimension determined from an equation of motion of the dynamic system.

However, a singular value of a parallel projection Θ calculated from actual system input and output moderately and monotonically decreases in many cases. In these cases, a boundary between a singular value having a significant value and a singular value corresponding to a minute value that can be ignored is unclear. Therefore, the conventional system identification device disclosed in Non Patent Literature 1 has a problem in that a system dimension is determined depending on judgment of an operator, so that an optimum system dimension may not be determined at all times, or trial and error is required to determine the system dimension.

In addition, an equation of motion obtained by modeling a dynamic system has difficulty in describing all actual dynamic characteristics of the dynamic system. There is a commonly held view that “a system dimension determined from an equation of motion<an actual system dimension of a dynamic system”. Therefore, the conventional system identification device disclosed in Patent Literature 1 originally has a problem in that an optimum system dimension for describing a dynamic system cannot be determined.

Further, in the conventional pseudorandom-input-based system identification device, stability of a linear discrete-time system (A_{d}, B_{d}, C_{d}, D_{d}) obtained as a result of identification has not been considered at all. Thus, there has been a problem in that, even when an actual dynamic system is stable, the system may be identified as an unstable system.

The present invention is made in view of the above circumstances, and its object is to provide a system identification device capable of eliminating trial and error from determination of a system dimension and determining an optimum system dimension, even when a singular value of a parallel projection Θ calculated from actual system input and output moderately and monotonically decreases, and thus a boundary between a singular value having a significant value and a singular value corresponding to a minute value that can be ignored is unclear.

In addition, an object of the present invention is to provide a system identification device capable of restrictively identifying a stable system when it is clear that an actual dynamic system is stable.

### Solution to Problem

In order to solve the above-mentioned problems and achieve the object, the present invention provides a system identification device receiving system input and output obtained when a pseudorandom input is applied to a dynamic system to be identified and a designated search range of a system dimension as inputs, the system identification device comprising: a system input/output extractor to extract input and output data for identification applied to identification from the system input and output of the dynamic system; a block Hankel matrix generator to generate block Hankel matrices based on the input and output data for identification; an input/output vector generator to generate an input vector and an output vector of the dynamic system based on the block Hankel matrix; an LQ decomposition unit to generate a data matrix by combining the block Hankel matrices, and output submatrices of an LQ decomposition of the data matrix; a parallel projection generator to generate a parallel projection based on the submatrices and the block Hankel matrices; a singular value decomposition unit to output a first orthogonal matrix, a column vector of which corresponds to a singular vector of the parallel projection, a second orthogonal matrix, a column vector of which corresponds to a right singular vector of the parallel projection, and a singular value of the parallel projection, based on singular value decomposition of the parallel projection; a system dimension determination unit to identify a system matrix of a linear discrete-time system describing the dynamic system with respect to each dimension belonging to the search range, based on the second orthogonal matrix and the singular value, the input vector and the output vector of the dynamic system, and the search range, and determine a system dimension from a comparison between a system characteristic of the linear discrete-time system calculated based on the system matrix and an actual system characteristic of the dynamic system; a state vector generator to generate a state vector of the dynamic system based on the second orthogonal matrix and the singular value, and the determined system dimension; and a system matrix identification unit to identify a system matrix of the linear discrete-time system describing the dynamic system based on the input vector and the output vector of the dynamic system, and the state vector of the dynamic system, wherein the identified system matrix is outputted as the linear discrete-time system describing the dynamic system.

### Advantageous Effects of Invention

According to the invention, with regard to a dynamic system to be identified, trial and error can be eliminated from determination of a system dimension, an optimum system dimension can be determined at all times, and a linear discrete-time system that describes the dynamic system can be identified, even when a singular value of a parallel projection calculated from actual system input and output moderately and monotonously decreases, and thus a boundary between a singular value having a significant value and a singular value being a minute value that can be ignored is unclear.

### BRIEF DESCRIPTION OF DRAWINGS

FIG. 1 is a block diagram illustrating a whole configuration of a system identification device according to a first embodiment and a second embodiment.

FIG. 2 is a schematic chart showing a time waveform of system input and output in the system identification device of the first embodiment.

FIG. 3 is a schematic chart showing a relation between a singular value of a parallel projection and a dimension in the system identification device according to the first embodiment and the second embodiment.

FIG. 4 is a block diagram illustrating an internal configuration of a system dimension determination unit in the system identification device according to the first embodiment.

FIG. 5 is a schematic chart showing a relation between a dimension and a norm of sum of squares of errors in a time domain or a frequency domain of an identified linear discrete-time system in the system identification device according to the first embodiment and the second embodiment.

FIG. 6 is a schematic chart showing a time waveform of system input and output obtained when M-sequence vibration is applied to a dynamic system in the system identification device of the second embodiment.

FIG. 7 is a block diagram illustrating an internal configuration of a system dimension determination unit in the system identification device of the second embodiment.

FIG. 8 is a block diagram illustrating a whole configuration according to a third embodiment.

### DESCRIPTION OF EMBODIMENTS

Hereinafter, a system identification device according to embodiments of the present invention will be described with reference to accompanying drawings. It should be noted that the invention is not restricted by the embodiments described below.

### First Embodiment

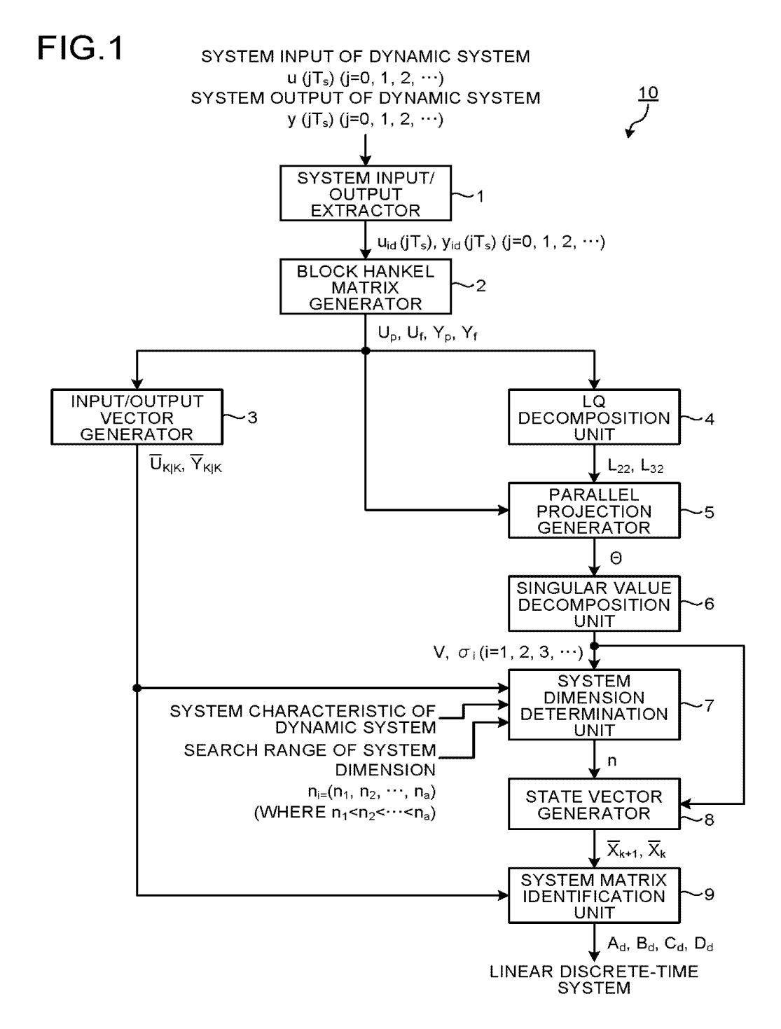

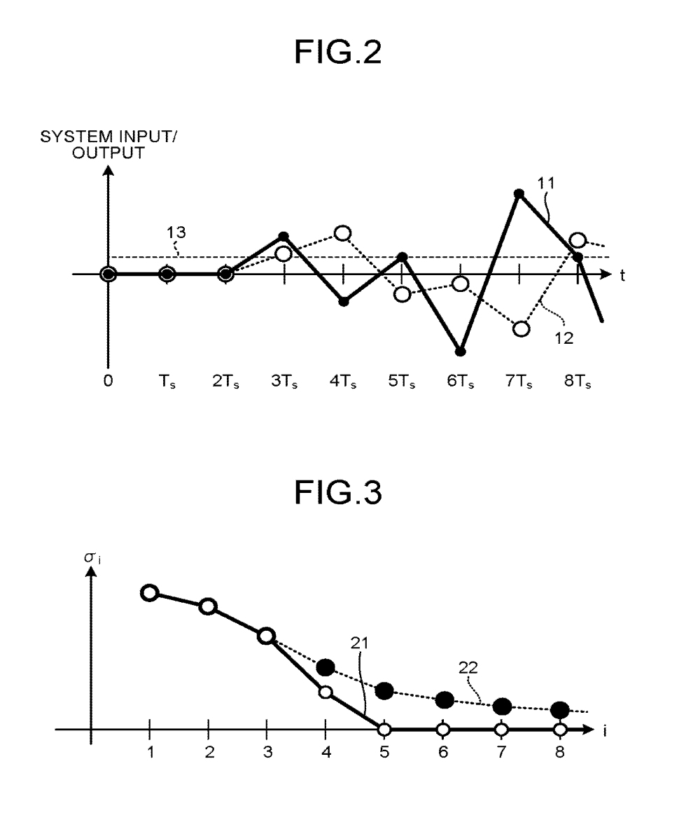

FIG. 1 is a block diagram illustrating a whole configuration of a system identification device according to a first embodiment, and FIG. 2 is a schematic chart showing a time waveform of system input and output in the system identification device of the first embodiment.

As illustrated in FIGS. 1 and 2, a system identification device 10 according to the first embodiment receives, as inputs, a system input 11 (u(jT_{S}) (j=0, 1, 2, . . . )) and a system output 12 (y(jT_{S}) (j=0, 1, 2, . . . )) obtained when a pseudorandom input is applied to a dynamic system to be identified.

With respect to a system input threshold value 13 determined by a value obtained by multiplying a preset ratio threshold value by a maximum value of the system input 11, a system input/output extractor 1 sets a minimum value of times at which an absolute value of the system input 11 is greater than or equal to the system input threshold value 13 as a pseudorandom input application time (3T, in FIG. 2), and extracts and outputs the system input 11 and the system output 12 on or after the pseudorandom input application time as input data for identification (U_{id}(jT_{S}) (j=0, 1, 2, . . . )) and output data for identification (y_{id}(jT_{S}) (j=0, 1, 2, . . . )), respectively.

A block Hankel matrix generator 2 generates block Hankel matrices Uₚ, U_{f}, and Yₚ, Iₜ based on the input data for identification (u_{id}(jT_{S}) (j=0, 1, 2, . . . )) and the output data for identification (y_{id}(jT_{S}) (j=0, 1, 2, . . . )) outputted from the system input/output extractor 1.

An input/output vector generator 3 generates an input vector ^{˜}U_{K|K} and an output vector ^{˜}Y_{K|K} of the dynamic system based on the block Hankel matrices Uₚ, U_{f}, Yₚ, Y_{f}.

An LQ decomposition unit 4 generates a data matrix obtained by combining the block Hankel matrices Uₚ, U_{f}, Yₚ, Y_{f}, and generates and outputs submatrices L₂₂, L₃₂ obtained from the LQ decomposition of the data matrix.

A parallel projection generator 5 generates a parallel projection Θ of the dynamic system based on the submatrices L₂₂, L₃₂) outputted from the LQ decomposition unit 4 and the block Hankel matrices Uₚ, Yₚ outputted from the block Hankel matrix generator 2.

A singular value decomposition unit 6 applies singular value decomposition to the parallel projection Θ outputted from the parallel projection generator 5, and outputs a first orthogonal matrix U, a column vector of which corresponds to a left singular vector of the parallel projection Θ, a second orthogonal matrix V, a column vector of which corresponds to a right singular vector of the parallel projection Θ, and singular value σᵢ (i=1, 2, 3 . . . ) of the parallel projection Θ.

A system dimension determination unit 7 identifies a system matrix of a linear discrete-time system that describes the dynamic system with respect to each dimension nᵢ=1, 2, . . . , a) belonging to a search range nᵢ=(n₁, n₂, . . . , nₐ) (where n₁<n₂< . . . <nₐ) of a system dimension designated by an operator based on the second orthogonal matrix V and the singular value σᵢ (i=1, 2, 3 . . . ) outputted from the singular value decomposition unit 6, the input vector ^{˜}U_{K|K}(and the output vector ^{˜}Y_{K|K} of the dynamic system outputted from the input/output vector generator 3, and the search range. Further, the system dimension determination unit 7 calculates a system output obtained when actual input data for identification u_{id}(jT_{S}) (j=0, 1, 2, . . . ) is applied to a linear discrete-time system corresponding to each of the dimension nᵢ (i =1, 2, . . . , a) belonging to the search range, based on the system matrix, and determines a system dimension n from a comparison with actual output data for identification Y_{id}(jT_{S}) (j=0, 1, 2, . . . ) of the dynamic system (described as a system characteristic of the dynamic system in FIG. 1).

A state vector generator 8 generates state vectors ^{˜}X_{K}, ^{˜}X_{K+1} of the dynamic system based on the second orthogonal matrix V and the singular value σᵢ (i=1, 2, 3 . . . ) outputted from the singular value decomposition unit 6, and the system dimension n outputted from the system dimension determination unit 7.

A system matrix identification unit 9 identifies and outputs system matrices A_{d}, B_{d}, C_{d} and D_{d} of the linear discrete-time system that describes the dynamic system based on the input vector ^{˜}U_{K|K} and the output vector ^{˜}Y_{K|K} of the dynamic system outputted from the input/output vector generator 3, and the state vectors ^{˜}X_{K+1}, ^{˜}X_{K} of the dynamic system outputted from the state vector generator 8.

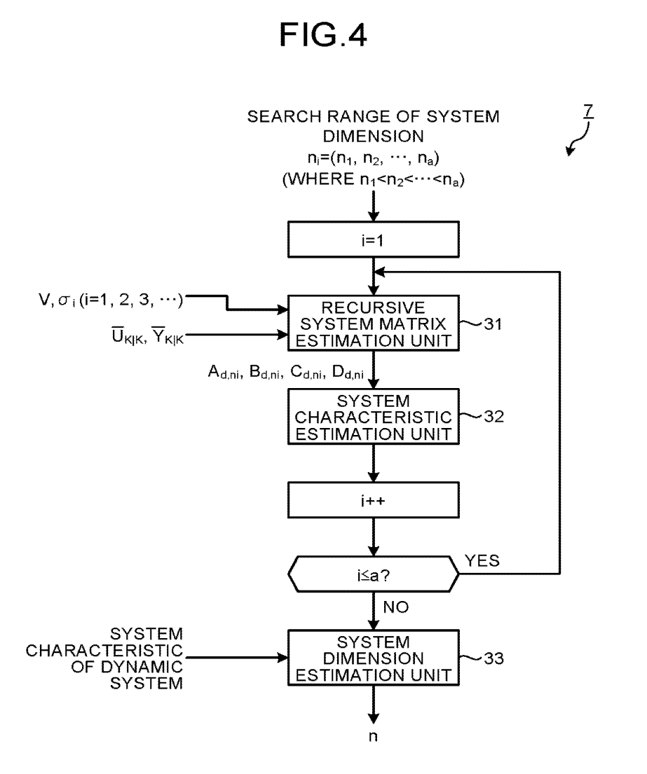

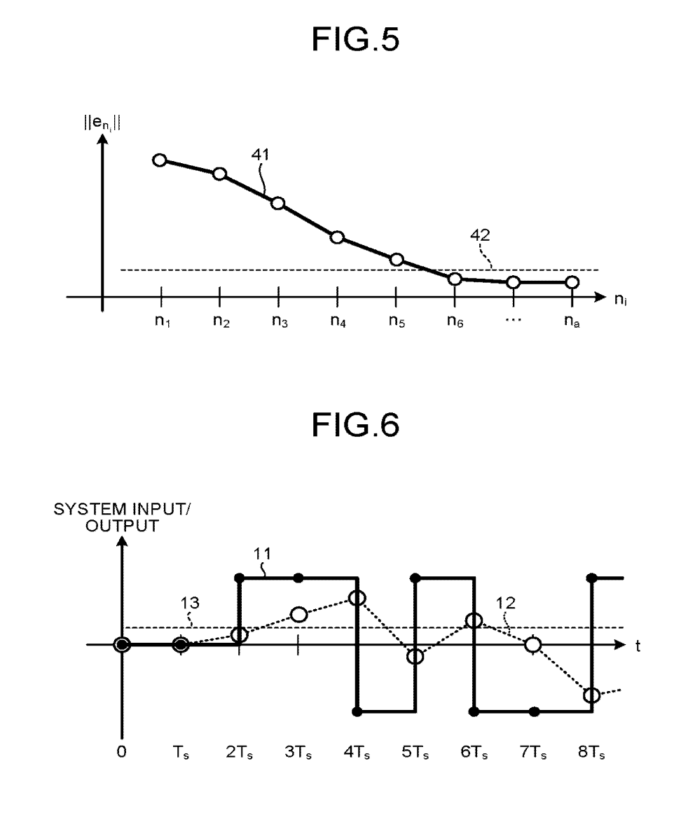

FIG. 3 is a schematic chart showing a relation between the singular value σᵢ of the parallel projection Θ and a dimension (i=1, 2, 3 . . . ) in the system identification device 10 according to the first embodiment. FIG. 4 is a block diagram illustrating an internal configuration of the system dimension determination unit 7 in the system identification device 10 according to the first embodiment. FIG. 5 is a schematic chart showing a relation between a dimension nᵢ (i=1, 2, . . . , a) and, a norm ∥eₙ∥ of sum of squares of errors in the time domain of a system output of an identified linear discrete-time system and an actual system output of a dynamic system in the system identification device 10 according to the first embodiment.

As shown in FIG. 3, a singular value σᵢ (i=1, 2, 3 . . . ) of a parallel projection Θ calculated from the system input and output of the dynamic system ideally has a relation, for example, illustrated in a singular value distribution 21 with respect to a dimension (i=1, 2, 3 . . . ). In this case, the number of singular values having significant values can be clearly defined, and the number corresponds to a system dimension n of the dynamic system (the system dimension n=4 in the case of FIG. 3).

On the other hand, a singular value σ₁ calculated based on the actual system input and output influenced by observation noise or the like has a relation, for example, illustrated in a singular value distribution 22 with respect to a dimension (i=1, 2, 3 . . . ). Thus, a boundary between a singular value having a significant value and a singular value that is a minute value that can be ignored is indefinite, so that an optimum system dimension n may not be determined at all times. Therefore, there occurs a problem in that trial and error is necessary for determination of the system dimension n.

In this regard, in the system identification device 10 according to the first embodiment, processing illustrated in FIG. 4 is executed by the system dimension determination unit 7. Details are described below.

The system dimension determination unit 7 includes a recursive system matrix estimation unit 31, a system characteristic estimation unit 32 and a system dimension estimation unit 33.

With regard to identification of a system matrix corresponding to a first dimension so belonging to the search range nᵢ=(n₁, n₂, . . . nₐ) (where n₁<n₂< . . . <nₐ) of the system dimension designated in advance by the operator, the recursive system matrix estimation unit 31 identifies system matrices A_{d}, nᵢ, B_{d}, nᵢ, C_{d}, nᵢ, D_{d}, nᵢ associated with the first dimension nᵢ through a recursive method, using: an identification result of the system matrices A_{d}, nᵢ₋₁, B_{d}, nᵢ₋₁, C_{d}, nᵢ₋₁, D_{d}, nᵢ₋₁ corresponding to a second dimension lower than the first dimension nᵢ by one level; a right singular vector vⱼ and a singular value σⱼ (j=nᵢ₋₁+1, nᵢ₋₁+2, . . . , nᵢ), each of which corresponds to a dimension greater than the second dimension nᵢ₋₁ and less than or equal to the first dimension nᵢ, from among the second orthogonal matrix V and the singular value σᵢ (i=1, 2, 3 . . . ) outputted from the singular value decomposition unit 6; and the input vector ^{˜}U_{K|K} and the output vector ^{˜}Y_{K|K} of the dynamic system outputted from the input/output vector generator 3.

Subsequently, the system characteristic estimation unit 32 calculates a system output obtained when the actual input data for identification u_{id}(jT_{S}) (j=0, 1, 2, . . . ) is applied to the identified linear discrete-time system, based on the system matrices A_{d}, nᵢ, B_{d}, n₁, C_{d}, n₁, D_{d}, nᵢ outputted from the recursive system matrix estimation unit 31, with respect to each dimension belonging to the search range nᵢ=(n₁, n₂, . . . nₐ) (where n₁<n₂< . . . <nₐ) of the system dimension.

Processing of the recursive system matrix estimation unit 31 and the system characteristic estimation unit 32 is executed until i becomes “a” by incrementing i.

The system dimension estimation unit 33 is configured to calculate a sum of squares of errors eₙᵢ (i=1, 2, . . . , a) in the time domain of the system output of the linear discrete-time system outputted from the system characteristic estimation unit 32 and the actual output data for identification y_{id}(jT_{S}) (j=0, 1, 2, . . . ) of the dynamic system (described as a system characteristic of the dynamic system in FIG. 4), and determine a minimum dimension from among dimensions at which a distribution 41 of the norm ∥eₙᵢ∥ of a sum of squares of errors is less than or equal to a norm threshold value 42 of the sum of squares of errors set in advance as illustrated in FIG. 5, to be a system dimension n, and outputs the system dimension n (in the case of FIG. 5, the system dimension n=n₆).

Next, a description will be given for an operation of the system identification device according to the first embodiment.

It is presumed that the dynamic system to be identified can be described as a 1-input and P-output n-dimensional linear discrete-time system as in the following equation.

x((j+1)Tₛ)=A_{d}x(jTₛ)+B_{d}u(jTₛ)

y(jTₛ)=C_{d}x(jTₛ)+D_{d}u(jTₛ) [Formula 1]

where a state vector: x ∈ Rⁿ
a system input: u ∈ R
a system output: y ∈ R^{P}
system matrices: A_{d} ∈ R^{n×n}, B_{d} ∈ R^{M}, C_{d} ∈ R^{P×n},D_{d} ∈ R^{P}

When a system input u(jT_{S}) to the dynamic system is configured as a pseudorandom input, the system input u(jT_{S}) and the system output y(jT_{S}) corresponding to the above [Formula 1] have time waveforms, for example, as shown in the system input 11 and the system output illustrated in FIG.

Here, as described above with reference to FIGS. 1 and 2, the following expression obtained by multiplying the preset ratio threshold value by a maximum value of the system input 11 (u(jT_{S})) is used as the system input threshold value 13.

System input ratio, threshold value·max(u(jTₛ)) [Formula 2]

The system input/output extractor 1 identifies a minimum value of times at which an absolute value of the system input 11 is greater than or equal to the system input threshold value 13 as a pseudorandom input application time jₘᵢₙT_{S} (in the case of FIG. 2, jₘᵢₙT_{S}=3T_{S}).

In addition, the system input/output extractor 1 extracts the system input 11 and the system output 12 on or after the pseudorandom input application time jₘᵢₙT_{S} using the following equation.

u_{id} (jTₛ)=u((jₘᵢₙ+j)Tₛ) (j=0,1,2, . . . )

y_{id} (jTₛ)=y((jₘᵢₙ+j)Tₛ) (j=0,1,2, . . . ) Formula 3]

Further, the system input/output extractor 1 sets the values extracted using the above [Formula 3] as the input data for identification u_{id}(jT_{S}) and the output data for identification y_{id}(jT_{S}), thereby removing system stationary time domain data obtained before the pseudorandom input is applied, from the system input and output of the target dynamic system.

The block Hankel matrix generator 2 generates block Hankel matrices Uₚ, U_{f}, Yₚ and Y_{f} given by the following equations on the basis of the input data for identification u_{id}(jT_{S}) (j−0, 1, 2, . . . ) and the output data for identification y_{id}(jT_{S}) (j=0, 1, 2, . . . ) outputted from the system input/output extractor 1.

$$[ Formula 4 ]$$

$${U}_{p} = {U}_{0 \vert K - 1} = [ \begin{matrix}u ( 0 ) & u ( {T}_{s} ) & … & u ( ( N - 1 ) {T}_{s} ) \\ u ( {T}_{s} ) & u ( 2 {T}_{s} ) & … & u ( {NT}_{s} ) \\ ⋮ & ⋮ & ⋱ & ⋮ \\ u ( ( K - 1 ) {T}_{s} ) & u ( {KT}_{s} ) & … & u ( ( K + N - 2 ) {T}_{s} )\end{matrix} ] ∈ {R}^{K \times N}$$

$${Y}_{p} = {Y}_{0 \vert K - 1} = [ \begin{matrix}y ( 0 ) & y ( {T}_{s} ) & … & y ( ( N - 1 ) {T}_{s} ) \\ y ( {T}_{s} ) & y ( 2 {T}_{s} ) & … & y ( {NT}_{s} ) \\ ⋮ & ⋮ & ⋱ & ⋮ \\ y ( ( K - 1 ) {T}_{s} ) & y ( {KT}_{s} ) & … & y ( ( K + N - 2 ) {T}_{s} )\end{matrix} ] ∈ {R}^{KP \times N}$$

$${U}_{f} = {U}_{K \vert 2 K - 1} = [ \begin{matrix}u ( {KT}_{s} ) & u ( ( K + 1 ) {T}_{s} ) & … & u ( ( K + N - 1 ) {T}_{s} ) \\ u ( ( K + 1 ) {T}_{s} ) & u ( ( K + 2 ) {T}_{s} ) & … & u ( ( K + N ) {T}_{s} ) \\ ⋮ & ⋮ & ⋱ & ⋮ \\ u ( ( 2 K - 1 ) {T}_{s} ) & u ( 2 {KT}_{s} ) & … & u ( ( 2 K + N - 2 ) {T}_{s} )\end{matrix} ] ∈ {R}^{K \times N} \\ {Y}_{f} = {Y}_{K \vert 2 K - 1} = [ \begin{matrix}y ( {KT}_{s} ) & y ( ( K + 1 ) {T}_{s} ) & … & y ( ( K + N - 1 ) {T}_{s} ) \\ y ( ( K + 1 ) {T}_{s} ) & y ( ( K + 2 ) {T}_{s} ) & … & y ( ( K + N ) {T}_{s} ) \\ ⋮ & ⋮ & ⋱ & ⋮ \\ y ( ( 2 K - 1 ) {T}_{s} ) & y ( 2 {KT}_{s} ) & … & y ( ( 2 K + N - 2 ) {T}_{s} )\end{matrix} ] ∈ {R}^{KP \times N}$$

The input/output vector generator 3 generated an input vector ⁻U_{K|K} and an output vector ⁻Y_{K|K} of the dynamic system given by the following equations on the basis of the block Hankel matrices Uₚ, U_{f}, Yₚ and Y_{f}.

Ū_{K|K}=[u(KTₛ)u((K+1)Tₛ) . . . u((K+N−2)T_{S})]=U _{f}(1,1:N−1)∈ R^{1x(N-1)}

Y̅_{K|K}=[y(KTₛ) y((K+1)Tₛ) . . . y((K+N−2)T_{S})]=Y _{f}(1:P,1:N−1)∈ R ^{Px(N-1}) [Equation 5]

The LQ decomposition unit 4 generates a data matrix given by the following expression obtained by combining the block Hankel matrices Uₚ, U_{f}, Yₚ and Y_{f}.

$$[ \begin{matrix}{U}_{f} \\ {U}_{p} \\ {Y}_{p} \\ {Y}_{f}\end{matrix} ] \qquad [ Formula 6 ]$$

In addition, the LQ decomposition unit 4 calculates the LQ decomposition of the above data matrix as in the following equation, and outputs submatrices L₂₂ and L₃₂ from elements of the LQ decomposition of the data matrix.

$$\begin{matrix}[ \begin{matrix}{U}_{f} \\ {U}_{p} \\ {Y}_{p} \\ {Y}_{f}\end{matrix} ] = [ \begin{matrix}{L}_{11} & 0 & 0 \\ {L}_{21} & {L}_{22} & 0 \\ {L}_{31} & {L}_{32} & {L}_{33}\end{matrix} ] [ \begin{matrix}{Q}_{1}^{T} \\ {Q}_{2}^{T} \\ {Q}_{3}^{T}\end{matrix} ] & [ Formula 7 ] \\ where the orthogonal matrix \text{:} \\ {Q}_{1} ∈ {R}^{N \times K} , {Q}_{2} ∈ {R}^{N \times K ( 1 + P )} , {Q}_{3} ∈ {R}^{N \times KP} \\ the block \text{-} underside triangular matrix \text{:} \\ {L}_{11} ∈ {R}^{K \times K} , {L}_{22} ∈ {R}^{K ( 1 + P ) \times K ( 1 + P )} , {L}_{33} ∈ {R}^{KP \times KP} \\ {L}_{21} ∈ {R}^{K ( 1 + P ) \times K} , {L}_{31} ∈ {R}^{KP \times K} , {L}_{32} ∈ {R}^{KP \times K ( 1 + P )} & \end{matrix}$$

The parallel projection generator 5 generates a parallel projection Θ of the dynamic system defined by the following equation on the basis of the submatrices L₂₂ and L₃₂ outputted from the LQ decomposition unit 4 and the block Hankel matrices Uₚ and Yₚ outputted from the block Hankel matrix generator 2.

$$Θ = {L}_{32} {L}_{22}^{†} [ \begin{matrix}{U}_{p} \\ {Y}_{p}\end{matrix} ] ∈ {R}^{KP \times N} \qquad [ Formula 8 ]$$

The singular value decomposition unit 6 calculates a singular value decomposition of the parallel projection Θ expressed by the above equation, thereby to output a first orthogonal matrix U, a column vector of which corresponds to a left singular vector uⱼ of a parallel projection Θ obtained by the following equation, a second orthogonal matrix V, a column vector of which corresponds to a right singular vector vⱼ of the parallel projection Θ, and a singular value σᵢ (i=1, 2, 3 . . . ) of the parallel projection Θ.

$$\begin{matrix}Θ = U \sum {V}^{T} & [ Formula 9 ] \\ where the first orthogonal matrix \text{:} \\ U = [ \begin{matrix}{u}_{1} & {u}_{2} & … & {u}_{KP}\end{matrix} ] ∈ {R}^{KP \times KP} \\ the second orthogonal matrix \text{:} \\ V = [ \begin{matrix}{v}_{1} & {v}_{2} & … & {v}_{N}\end{matrix} ] ∈ {R}^{N \times N} \\ the singular value of parallel projection : {σ}_{1} \geq {σ}_{2} \geq … \geq {σ}_{n} \geq {σ}_{n + 1} \geq {σ}_{n + 2} \geq … \\ \sum = [ \begin{matrix}{σ}_{1} & & 0 \\ & {σ}_{2} & \\ 0 & & ⋱\end{matrix} ] ∈ {R}^{KP \times N} & \end{matrix}$$

A system dimension n of the target dynamic system can determined based on the following relation in which, of all singular values of the parallel projection Θ, n singular values have significant values, and an (n+1)th or subsequent singular values have sufficiently smaller values than the n singular values.

σ₁≧σ₂≧ . . . ≧σₙ□σₙ₊₁≧σₙ₊₂≧ [Formula 10]

As illustrated in FIG. 3, a singular value σᵢ of a parallel projection Θ calculated from the system input and output of the dynamic system ideally has a relation, for example, illustrated in the singular value distribution 21 with respect to a dimension (i=1, 2, 3 . . . ). In this case, the number of singular values having significant values can be clearly defined, and a system dimension n of the dynamic system can be determined from the number (the system dimension n=4 in the case of FIG. 3). On the other hand, a singular value σᵢ calculated based on the actual system input and output influenced by observation noise or the like has a relation, for example, illustrated in the singular value distribution 22 with respect to a dimension (i=1, 2, 3 . . . ). Thus, a boundary σₙ>>σₙ₊₁ between a singular value having a significant value and a singular value that is an ignorable minute value is unclear. Therefore, a conventional scheme has a problem in that an optimum system dimension n may not be determined at all times, and trial and error is necessary for determination of the optimum system dimension n.

In this regard, the system identification device 10 according to the first embodiment determines an optimum system dimension n in the system dimension determination unit 7 on the assumption that the optimum system dimension n is “most suitable for the actual system input and output in the time domain”. As illustrated in FIG. 1, the system dimension determination unit 7 identifies a system matrix of a linear discrete-time system that describes the dynamic system with respect to each of the dimension nᵢ=(i=1, 2, . . . , a) belonging to a search range nᵢ=(n₁, n₂, . . . , nₐ) (where n₁<n₂< . . . <n_{d}) of a system dimension designated by the operator, on the basis of the second orthogonal matrix V and the singular value σᵢ (i=1, 2, 3 . . . ) outputted from the singular value decomposition unit 6, the input vector ^{˜}U_{K|K} and the output vector ^{˜}Y_{K|K} of the dynamic system outputted from the input/output vector generator 3, and the search range. Further, the system dimension determination unit 7 calculates a system output obtained when the actual input data for identification u_{id}(jT_{S}) (j=0, 1, 2, . . . ) is applied to a linear discrete-time system corresponding to each dimension nᵢ (i=1, 2, . . . , a) belonging to the search range on the basis of the system matrix, and determines a system dimension n from a comparison with actual output data for identification Y_{id}(jT_{S}) (j=0, 1, 2, . . . ) of the dynamic system (described as a system characteristic of the dynamic system in FIG. 1).

Specifically, as illustrated in FIG. 4, the recursive system matrix estimation unit 31 identifies, with regard to identification of a system matrix corresponding to a first dimension nᵢ belonging to the search range nᵢ=n₁, n₂, . . . nₐ) (where n₁<n₂<<nₐ) of the system dimension designated by the operator, system matrices A_{d}, nᵢ, B_{d}, nᵢC_{d}, nᵢ, and D_{d}, nᵢ corresponding to the first dimension nᵢ through a recursive method shown in the equations, using an identification result of system matrices A_{d}, nᵢ₋₁, B_{d}, nᵢ₋₁, C_{d}, nᵢ₋₁, and D_{d}, nᵢ₋₁ corresponding to a second dimension lower than the first dimension nᵢ by one level, a right singular vector vⱼ and a singular value σⱼ (j−nᵢ₋₁+1, nᵢ₋₁+2, . . . , n₁), each of which corresponds to a dimension greater than the second dimension and less than or equal to the first dimension nᵢ, from among the second orthogonal matrix V and the singular value σᵢ (i=1, 2, 3 . . . ) outputted from the singular value decomposition unit 6, and the input vector ^{˜}U_{K|K} and the output vector ^{˜}U_{K|K} of the dynamic system outputted from the input/output vector generator 3.

$$\begin{matrix} [ Formula 11 ] \\ State vector corresponding to the first dimension {n}_{i} : \\ \begin{matrix}{X}_{f , {n}_{i}} \approx {\sum }_{{n}_{i}}^{1 / 2} {V}_{{n}_{i}}^{T} = [ \begin{matrix}\frac{{X}_{f , {n}_{i - 1}}}{\sqrt{{σ}_{{n}_{i - 1} + 1}} {v}_{{n}_{i - 1} + 1}^{T}} \\ ⋮ \\ \sqrt{{σ}_{{n}_{i}}} {v}_{{n}_{i}}^{T}\end{matrix} ] ∈ {R}^{{n}_{i} \times N} \\ = \{ \begin{matrix}\sum {( 1 \text{:} {n}_{i} , 1 \text{:} {n}_{i} )}^{1 / 2} {V ( \text{:} , 1 \text{:} {n}_{i} )}^{T} & ( {n}_{i} = {n}_{1} ) \\ [ \begin{matrix}{X}_{f , {n}_{i - 1}} \\ \sum {( {n}_{i - 1} + 1 \text{:} {n}_{i} , {n}_{i - 1} + 1 \text{:} {n}_{i} )}^{1 / 2} {V ( \text{:} , {n}_{i - 1} + 1 \text{:} {n}_{i} )}^{T}\end{matrix} ] & ( {n}_{i} > {n}_{1} )\end{matrix} \\ {\overline{X}}_{K + 1 , {n}_{i}} = [ \begin{matrix}x ( ( K + 1 ) {t}_{s} ) & x ( ( K + 2 ) {t}_{s} ) & … & x ( ( K + N - 1 ) {t}_{s} )\end{matrix} ] \\ = {X}_{f , {n}_{i}} ( \text{:} , 2 \text{:} N ) ∈ {R}^{{n}_{i} \times ( N - 1 )} \\ {\overline{X}}_{K , {n}_{i}} = [ \begin{matrix}x ( {Kt}_{s} ) & x ( ( K + 1 ) {t}_{s} ) & … & x ( ( K + N - 2 ) {t}_{s} )\end{matrix} ] \\ = {X}_{f , {n}_{i}} ( \text{:} , 1 \text{:} N - 1 ) ∈ {R}^{{n}_{i} \times ( N - 1 )}\end{matrix} & & \\ ⇒ System matrices {A}_{d} , {n}_{i} , {B}_{d} , {n}_{i} , {C}_{d} , {n}_{i} , {D}_{d} , {n}_{i} \\ corresponding to the first dimension ni \text{:} \\ [ \begin{matrix}{A}_{d , {n}_{i}} & {B}_{d , {n}_{i}} \\ {C}_{d , {n}_{i}} & {D}_{d , {n}_{i}}\end{matrix} ] = ( {[ \begin{matrix}{\overline{X}}_{K + 1 , {n}_{i}} \\ {\overline{Y}}_{K \vert K}\end{matrix} ] [ \begin{matrix}{\overline{X}}_{K , {n}_{i}} \\ {\overline{U}}_{K \vert K}\end{matrix} ]}^{T} ) {( {[ \begin{matrix}{\overline{X}}_{K , {n}_{i}} \\ {\overline{U}}_{K \vert K}\end{matrix} ] [ \begin{matrix}{\overline{X}}_{K , {n}_{i}} \\ {\overline{U}}_{K \vert K}\end{matrix} ]}^{T} )}^{- 1} ∈ {R}^{( P + {n}_{i} ) \times ( 1 + {n}_{i} )} \\ where {A}_{d , {n}_{i}} ∈ {R}^{{n}_{i} \times {n}_{i}} , {B}_{d , {n}_{i}} ∈ {R}^{{n}_{i}} , {C}_{d , {n}_{i}} ∈ {R}^{P \times {n}_{i}} , {D}_{d , {n}_{i}} ∈ {R}^{P} & & \end{matrix}$$

The system characteristic estimation unit 32 calculates a system output ̂y_{id},nᵢ(jT_{S}) (j=0, 1, 2, . . . ) obtained when the actual input data for identification u_{id}(jT_{S}) (j=0, 1, 2, . . . ) (refer to [Formula 3]) is applied to the identified linear discrete-time system, based on the system matrices A_{d},nᵢ, B_{d},nᵢ, C_{d},nᵢ and D_{d},nᵢ outputted from the recursive system matrix estimation unit 31, with respect to each of the dimension nᵢ belonging to the search range nᵢ (n₁, n₂, . . . , nₐ) (where n₁<n₂<<nₐ) of the system dimension. A notation of “̂y” is an alternative notation meaning that a notation of “̂” is assigned directly over a character of “y”.

In addition, the system dimension estimation unit 33 calculates a sum of squares of errors en ᵢ (i=1, 2, . . . , a) in the time domain of the system output ̂y_{id},nᵢ(jT_{S}) (j=0, 1, 2, . . . ) of the linear discrete-time system outputted from the system characteristic estimation unit 32 and the actual output data for identification y_{id}(jT_{S}) (j=0, 1, 2, . . . ) of the dynamic system (described as a system characteristic of the dynamic system in FIG. 4), using the following equation.

$${e}_{{n}_{i}} = {\sum }_{j = 0}^{2 K + N - 1} {( {y}_{id} ( {jT}_{s} ) - {\hat{Y}}_{id , {n}_{i}} ( {jT}_{s} ) )}^{2} ∈ {R}^{P} \qquad [ Formula 12 ]$$

A dimension nᵢ at which a norm ∥enᵢ∥ of the sum of squares of errors shown in the above equation is the smallest becomes a system dimension n which is “most suitable for the actual system input and output in the time domain”. On the other hand, when the observation noise is of white noise, an actual norm ∥enᵢ∥ does not depend on a noise level thereof, and monotonously decreases as the dimension nᵢ increases and becomes nearly constant at a certain dimension or more as illustrated in FIG. 5. Therefore, herein, the threshold value 42 of a norm of a sum of squares of errors given by the following expression is defined to prevent an estimated value of the system dimension n from becoming a dimension higher than necessary.

Acceptable value of sum of squares of errors·min (∥enᵢ∥) Formula 13]

The system dimension estimation unit 33 determines a minimum dimension from among dimensions at which the distribution 41 of the norm of the sum of squares of errors ∥enᵢ∥ is less than or equal to the above-mentioned threshold value 42 of the norm of sum of squares of errors to be the system dimension n, and outputs the system dimension n (in an example of FIG. 5, the system dimension n=n₆).

The state vector generator 8 generates state vectors ^{˜}X_{K} and ^{˜}X_{K+1} of the dynamic system according to the following equations based on the second orthogonal matrix V and the singular value σ₁ (i=1, 2, 3 . . . ) outputted from the singular value decomposition unit 6, and the system dimension n outputted from the system dimension determination unit 7.

X_{f}=[x(KTₛ) x((K+1)Tₛ) . . . x((K+N−1)Tₛ)]

≈Σₙ^{1/2}Vₙ^{T}=Σ(1:n,1:n)^{1/2}V(:,1:n)^{T} ∈ R^{n×N}

X̅_{K+1}=[x((K+1)Tₛ) c((K+2)T_{S}. . . x((K+N−1)T_{S})]=X_{f}(:,2:N)∈ R^{nx(N-1)}

X̅_{K}=[x(KTₛ) x((K+1)T_{S}) . . . x((K+N−2)Tₛ)]=X^{f}(:,1:N−1)∈ R^{nx(N-1)} [Formula 14]

Finally, the system matrix identification unit 9 identifies and outputs, using the following equations, system matrices A_{d}, B_{d}, C_{d}and D_{d} of the linear discrete-time system that describes the dynamic system, based on the input vector ^{˜}U_{K|K} and the output vector ^{˜}U_{K|K} of the dynamic system outputted from the input/output vector generator 3, and the state vectors ^{˜}X_{K|K} and ^{˜}X_{K+1} of the dynamic system outputted from the state vector generator 8.

$$[ Formula 15 ] \\ [ \begin{matrix}{A}_{d} & {B}_{d} \\ {C}_{d} & {D}_{d}\end{matrix} ] = ( {[ \begin{matrix}{\overline{X}}_{K + 1} \\ {\overline{Y}}_{K \vert K}\end{matrix} ] [ \begin{matrix}{\overline{X}}_{K} \\ {\overline{U}}_{K \vert K}\end{matrix} ]}^{T} ) {( {[ \begin{matrix}{\overline{X}}_{K} \\ {\overline{U}}_{K \vert K}\end{matrix} ] [ \begin{matrix}{\overline{X}}_{K} \\ {\overline{U}}_{K \vert K}\end{matrix} ]}^{T} )}^{- 1} ∈ {R}^{( P + n ) \times ( 1 + n )}$$

$$where {A}_{d} ∈ {R}^{n \times n} , {B}_{d} ∈ {R}^{n} , {C}_{d} ∈ {R}^{P \times n} , {D}_{d} ∈ {R}^{P}$$

In this way, according to the system identification device 10 according to the first embodiment, trial and error can be eliminated from determination of a system dimension n, a system dimension n having a high degree of coincidence in the time dimension with respect an actual dynamic system can be determined, and a linear discrete-time system that describes the dynamic system can be identified even when a singular value σᵢ (i=1, 2, 3 . . .) of a parallel projection Θ calculated from the actual system input and output moderately and monotonously decreases, and thus a boundary between a singular value having a significant value and a singular value that is an ignorable minute value in identification is unclear.

In addition, identification accuracy can be improved by removing system stationary time domain data before application of a pseudorandom input from the actual system input and output of the dynamic system.

Further, the presence of the recursive system matrix estimation unit 31 can reduce the amount of computation for determining a system dimension n having a high degree of coincidence with respect to the actual dynamic system.

The system identification device 10 of the first embodiment calculates a system output, which is obtained when actual input data for identification are applied to a linear discrete-time system, as a system characteristic, and determines a minimum dimension among dimensions, at which the distribution 41 of the norm of sum of squares of errors in the time domain of the system output and actual output data for identification of a dynamic system is less than or equal to the threshold value 42, to be a system dimension n. However, the present invention is not limited thereto. The system characteristic of the linear discrete-time system may be calculated as a frequency response, and the system dimension n may be determined based on the sum of squares of errors in the frequency domain of the frequency response and an actual frequency response obtained from the input and output data for identification of the dynamic system. In this case, a weighting function may be further determined based on the actual frequency response of the dynamic system, and the system dimension n may be determined based on an addition value that is a value obtained by multiplying the value of squares of errors in the frequency domain of the frequency response of the linear discrete-time system and the actual frequency response of the dynamic system by the weighting function.

### Second Embodiment

Next, a description will be given for a system identification device according to a second embodiment. A block diagram illustrating a whole configuration of the system identification device according to the second embodiment, a schematic chart showing a relation between a dimension (i=1, 2, 5. . . ) and a singular value σᵢ of a parallel projection Θ, and a schematic chart showing a relation between a dimension nᵢ (i=1, 2, . . . , a) and the norm ∥enᵢ∥ of the sum of squares of errors in the frequency domain of a frequency response of an identified linear discrete-time system and an actual frequency response of a dynamic system are identical to FIGS. 1, 3 and 5, respectively, used in the description of the first embodiment.

FIG. 6 is a schematic chart showing a time waveform of system input and output obtained when M-sequence vibration is applied to a dynamic system in the system identification device of the second embodiment.

As illustrated in FIG. 6, the system identification device 10 according to the second embodiment identifies a linear discrete-time system that describes a dynamic system to be identified, based on a system input 11 (u(jT_{S}) (j=0, 1, 2, . . . )) and a system output 12 (y(jT_{S}) (j=0, 1, 2, . . . )) obtained when an M-sequence signal is applied to the dynamic system.

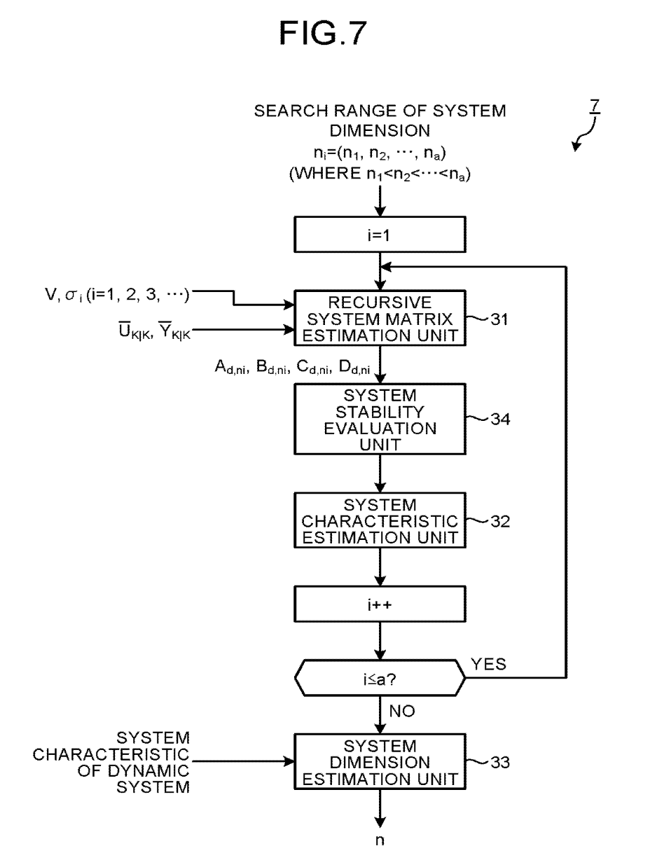

FIG. 7 is a block diagram illustrating an internal configuration of a system dimension determination unit 7 in the system identification device of the second embodiment. Referring to FIG. 7, a component provided with the same symbol as that of FIG. 4 is a constituent element same as or equivalent to that of the first embodiment, and a system stability evaluation unit 34 is additionally provided.

As illustrated in FIG. 7, in the system dimension determination unit 7 according to the second embodiment, the system stability evaluation unit 34 evaluates stability of a linear discrete-time system based on system matrices A_{d},nᵢ, B_{d},nᵢ, C_{d}, nᵢ, and D_{d},nᵢ identified by the recursive system matrix estimation unit 31, with respect to each of the dimension nᵢ belonging to a search range nᵢ =(n₁, n₂, . . . , nₐ) (where n₁<n₂<. . . <nₐ) of a system dimension designated by an operator.

The system characteristic estimation unit 32 calculates a frequency response for the identified linear discrete-time system, based on the system matrices A_{d},nᵢ, B_{d},nᵢ, C_{d},nᵢ, and D_{d},nᵢ outputted from the recursive system matrix estimation unit 31, with respect to a dimension at which the system is judged to be stable by the system stability evaluation unit 34.

The system dimension estimation unit 33 determines a weighting function based on an actual frequency response obtained from the system input and output of the dynamic system (described as a system characteristic of the dynamic system in FIG. 7), calculates an addition value enᵢ (nᵢ: dimension at which the system is stable) that is a value obtained by multiplying the value of squares of errors in the frequency domain of the frequency response of the linear discrete-time system outputted from the system characteristic estimation unit 32 and the actual frequency response of the dynamic system by the weighting function, determines a minimum dimension from among dimensions at which the distribution 41 of the norm ∥enᵢ∥ of the addition value is less than or equal to a threshold value 42 of the norm of the sum of squares of errors set in advance as illustrated in FIG. 5 to be a system dimension n, and outputs the system dimension n (in the case of FTG. 5, the system dimension n=n₆).

Next, a description will be given for an operation of the system identification device according to the second embodiment.

It is presumed that the dynamic system to be identified can be described by [Formula 1] as a 1-input and P-output n-dimensional linear discrete-time system. When a system input u(jT_{S}) to the dynamic system is configured in an M-sequence signal, the system input u(jT_{S}) and a system output y(jT_{S}) corresponding to [Formula 1] have time waveforms, for example, as with the system input 11 and the system output 12 illustrated in FIG. 6.

In the system identification device 10 according to the second embodiment, as illustrated in FIGS. 1 and 6, the system input/output extractor 1 sets [Formula 29 obtained by multiplying a preset ratio threshold value by a maximum value of the system input 11 (u(jT_{S})) as a system input threshold value 13, and identifies a minimum value of times at which an absolute value of the system input 11 is greater than or equal to the system input threshold value 13 as an M-sequence signal application time jₘᵢₙT_{S} (jₘᵢₙT_{S}=2T_{S}, in an example of FIG. 6).

In addition, the system input/output extractor 1 extracts the system input 11 and the system output 12 on or after the M-sequence signal application time jₘᵢₙT_{S} using [Formula 3], and sets the extracted input and output as input data for identification u_{id}(jT_{S}) and output data for identification y_{id}(jT_{S}), respectively, thereby removing system stationary time domain data, which is obtained before application of the M-sequence signal, from the system input and output of the target dynamic system.

Subsequently, similarly to the first embodiment, the block Hankel matrix generator 2 generates block Hankel matrices Uₚ, U_{f}, Yₚ and Y_{f} given by [Formula 4] , the input/output vector generator 3 generates an input vector ^{˜}U_{K|K} and an output vector ^{˜}Y_{K|K} of the dynamic system given by [Formula 5], and the LQ decomposition unit 4 calculates the LQ decomposition [Formula 7] of a data matrix ([Formula 6]) obtained by combining the block Hankel matrices Uₚ, U_{f}Yₚ and Y_{f}, and outputs the submatrices L₂₂ and L₃₂.

The parallel projection generator 5 generates a parallel projection Θ of the dynamic system defined by [Formula 8], and the singular value decomposition unit 6 calculates a singular value decomposition of the generated parallel projection Θ, thereby outputting a first orthogonal matrix U, a second orthogonal matrix V and a singular value σᵢ (i=1, 2, 3 . . . ) given by [Formula 9].

Processing illustrated in FIG. 7 is executed in the system dimension determination unit 7. First, the recursive system matrix estimation unit 31 identifies corresponding system matrices A_{d},nᵢ, B_{d}, nᵢ, C_{d},nᵢ and, D_{d},nᵢ, using the recursive method shown in [Formula 11], with respect to each of the dimension nᵢ belonging to a search range nᵢ =(n₁, n₂, . . . , nₐ) (where nₗ<n₂< . . . <nₐ) of a system dimension designated by the operator.

Subsequently, the system stability evaluation unit 34 evaluates a stability of the linear discrete-time system in respect of the following content, based on the system matrix A_{d},nᵢ identified by the recursive system matrix estimation unit 31, with respect to each of the dimension nᵢ belonging to the search range nᵢ =(n₁, n₂, . . . , nₐ) (where n₁<n₂< . . .<nₐ) of the system dimension designated by the operator.

Linear discrete-time system of the dimension nᵢ is stable [Formula 16]

[symbol] Absolute values of all eigenvalues of the system matrix A_{d,ni} are less than 1

[symbol] All eigenvalues of the system matrix A_{d,ni} are present within a unit circle

The system characteristic estimation unit 32 calculates a frequency response ̂Hnᵢ (kΔf) (k=0, 1, 2, . . . , N/2−1) of the identified linear discrete-time system, based on the system matrices A_{d},nᵢ, B_{d},nᵢ, C_{d}nᵢ, and D_{d},nᵢ generated by the recursive system matrix estimation unit 31, with respect to a dimension at which the system is judged to be stable by the system stability evaluation unit 34.

In the system identification device 10 of the second embodiment, an optimum system dimension n is determined by the system dimension estimation unit 33 on the assumption that the optimum system dimension n is “most suitable for an actual frequency response in the frequency domain”. Details thereof are described below.

First, an actual frequency response H(kΔf) (k=0, 1, 2, . . . , N/2−1) of the dynamic system (described as a system characteristic of the dynamic system in FIG. 7) obtained by an equation subsequent to the following equations is calculated from the finite discrete Fourier transform U_{id}(kΔf), Y_{id}(kΔf) (k=0, 1, 2, . . . , N/2−1) of input and output data for identification u_{id}(jT_{S}) and Y_{id}(jT_{S}) given by the following equations.

$$\begin{matrix}{U}_{id} ( k Δ f ) = \frac{T}{N} {\sum }_{j = 0}^{N - 1} {u}_{id} ( j {T}_{s} ) exp [ - i \cdot 2 π \frac{j k}{N} ] ( k = 0 , 1 , 2 , … , \frac{N}{2} - 1 ) & [ Formula 17 ] \\ {Y}_{id} ( k Δ f ) = \frac{T}{N} {\sum }_{j = 0}^{N - 1} {y}_{id} ( j {T}_{s} ) exp [ - i \cdot 2 π \frac{j k}{N} ] ( k = 0 , 1 , 2 , … , \frac{N}{2} - 1 ) & \\ where a sampling period \text{:} {T}_{s} = \frac{T}{N} \\ a sampling frequency \text{:} {f}_{s} = \frac{1}{{T}_{S}} = \frac{N}{T} \\ a frequency resolution \text{:} Δ f = \frac{1}{T} & \\ time \text{:} t = j {T}_{S} = \frac{j T}{N} \\ frequency \text{:} f = k Δ f = \frac{k}{T} & \\ H ( k Δ f ) = \frac{{Y}_{id} ( k Δ f ) {{U}_{id} ( k Δ f )}^{*}}{{U}_{id} ( k Δ f ) {{U}_{id} ( k Δ f )}^{*}} ( k = 0 , 1 , 2 , … , \frac{N}{2} - 1 ) & [ Formula 18 ]\end{matrix}$$

Subsequently, for example, a weighting function W(kΔf) (k=0, 1, 2, . . . , N/2−1) shown in the following equation is determined based on a frequency response H(kΔf) (k=0, 1, 2, . . . , N/2−1), which is obtained by assigning a weight to a high-gain and low-frequency region.

$$W ( k Δ f ) = \frac{\vert H ( k Δ f ) \vert}{k Δ f} ( k = 0 , 1 , 2 , … , \frac{N}{2} - 1 ) \qquad [ Formula 19 ]$$

Then, an addition value enᵢ (nᵢ: dimension at which the system is stable) that is a value obtained by multiplying a value of squares of errors in the frequency domain of the frequency response ̂Hnᵢ(kΔf) of the linear discrete-time system outputted from the system characteristic estimation unit 32 and the actual frequency response H(kΔf) of the dynamic system by the weighting function W(kΔf) is calculated using the following equation.

$${e}_{{n}_{i}} = {\sum }_{k = 0}^{N / 2 - 1} {( H ( k Δ f ) - {\hat{H}}_{{n}_{i}} ( k Δ f ) )}^{2} \cdot W ( k Δ f ) \qquad [ Formula 20 ]$$

A dimension at which the norm ∥enᵢ∥ of the weighted sum of squares of errors is the smallest becomes a stable system dimension n which is “most suitable for an actual frequency response in the frequency domain according to the weighting function”. Here, from among dimensions at which the distribution 41l of the norm ∥enᵢ∥ of the weighted sum of squares of errors is less than or equal to the threshold value 42 of the norm of the sum of squares of errors given by [Formula 13] as illustrated in FIG. 5, a minimum dimension is determined to be the system dimension n and output it (in the example of FIG. 5, the system dimension n−n₆).

The state vector generator 8 generates state vectors ^{˜}X_{K} and ^{˜}X_{K+1} of the dynamic system using [Formula 14], based on the second orthogonal matrix V and the singular value σᵢ (i=1, 2, 3 . . . ) outputted from the singular value decomposition unit 6, and the system dimension n outputted from the system dimension determination unit 7.

Finally, the system matrix identification unit 9 identifies and outputs system matrices A_{d}, B_{d}, C_{d} and D_{d} of the linear discrete-time system that describes the dynamic system using [Formula 15], based on the input vector ^{˜}U_{K|K} and the output vector ^{˜}Y_{K|K} of the dynamic system outputted from the input/output vector generator 3, and the state vectors ^{˜}X_{K} and ^{˜}X_{K+1} of the dynamic system outputted from the state vector generator 8.

In this way, according to the system identification device 10 according to the second embodiment, trial and error can be eliminated from determination of a system dimension n, a system dimension n having a high degree of coincidence can be determined according to a weighting function in the frequency domain, with respect to a real dynamic system, and a linear discrete-time system that describes the dynamic system can be identified, even when a singular value σᵢ (i=1, 2, 3 . . . ) of a parallel projection Θ calculated from the real system input and output moderately and monotonically decreases, and thus a boundary between a singular value having a significant value and a singular value being an ignorable minute value in the identification is unclear.

In addition, identification accuracy can be improved by removing system stationary time domain data before application of the N-sequence signal from the real system input and output of the dynamic system.

Further, the presence of the recursive system matrix estimation unit 31 allows reduction of the amount of computation for determining a system dimension n having high degree of coincidence with respect to the real dynamic system.

In addition, the presence of the system stability evaluation unit 34 allows identification of a linear discrete-time system restricted to a stable system when it is clear that a real dynamic system is a stable system.

The system identification device 10 of the second embodiment calculates a system characteristic of a linear discrete-time system as a frequency response, and determines, to be a system dimension n, a minimum dimension from among dimensions at which the distribution 41 of the norm of the sum of squares of errors in the frequency domain of the frequency response and an actual frequency response obtained from the input and output data for identification of a dynamic system is less than or equal to the threshold value 42 set in advance. However, the present invention is not limited thereto. A system output obtained when actual input data for identification are applied to the linear discrete-time system may be calculated as a system characteristic, and a system dimension n may be determined based on the sum of squares of errors in the time domain of the system output and the actual output data for identification of the dynamic system.

### Third Embodiment

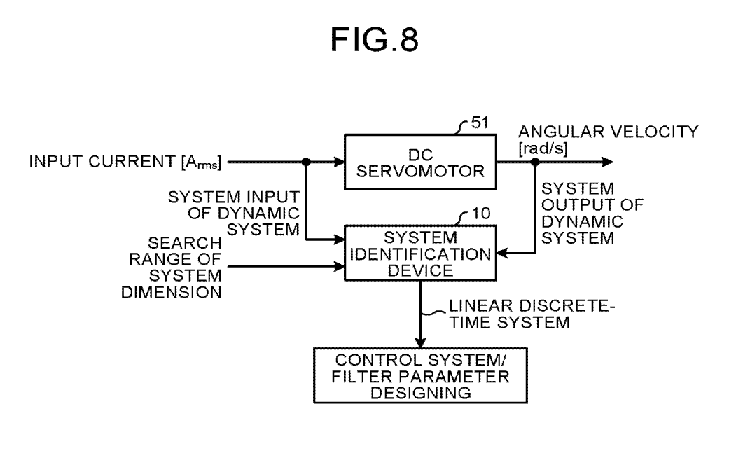

In the third embodiment, a description will be given for a case in which a dynamic system to be identified is a DC servomotor. FIG. 8 is a block diagram illustrating a whole configuration according to a third embodiment. In the present embodiment, a system identification device 10 illustrated in FIG. 8 has a configuration same as or equivalent to that of the system identification device 10 according to the first embodiment illustrated in FIG. 1. In the present embodiment, for example, a pseudorandom signal such as an h-sequence signal is inputted as an input current [Aᵣₘₛ] of a DC servomotor 51, and the pseudorandom signal is set as a system input 11 (u(jT_{S}) (j=0, 1, 2, . . . )) of the dynamic system. In addition, an angular velocity [rad/s] is acquired as a system output 12 (y(jT_{S}) (j=0, 1, 2, . . . )) of the dynamic system. The system identification device 10 receives the system input and output and a search range of a system dimension as inputs, and identifies a linear discrete-time system that describes the DC servomotor 51. In this instance, the search range of the system dimension may be preferably set to have a sufficient width with respect to a predicted system dimension, such as nᵢ=(1, 2, . . . , 50). The system identification device 10 allows determination of a system dimension having a high degree of coincidence with respect to a real dynamic system and identification of a linear discrete-time system that describes a dynamic system. Therefore, the linear discrete-time system can be used to design a parameter in a servomotor control system, a parameter of a filter, etc.

### REFERENCE SIGNS LIST

1 system input/output extractor, block Hankel matrix generator, 3 input/output vector generator, 4 LQ decomposition unit, 5 parallel projection generator, 6 singular value decomposition unit, 7 system dimension determination unit, 8 state vector generator, 9 system matrix identification unit, 10 system identification device, 11 system input, 12 system output, 13 system input threshold value, 21 singular value distribution (of parallel projection in ideal system input and output), 22 singular value distribution (of parallel projection in actual system input and output), 31 recursive system matrix estimation unit, 32 system characteristic estimation unit, 33 system dimension estimation unit, 34 system stability evaluation unit, 41 distribution of norm of a sum of squares of errors (in a time domain or frequency domain), 42 threshold value of norm of a sum of squares of errors (in a time domain or frequency domain), DC servomotor.

1. A system identification device receiving system input and output obtained when a pseudorandom input is applied to a dynamic system to be identified as an input, the system identification device comprising:
a system input/output extractor to extract input and output data for identification applied to identification from the system input and output of the dynamic system;
a block Hankel matrix generator to generate block Hankel matrices based on the input and output data for identification;
an input/output vector generator to generate an input vector and an output vector of the dynamic system based on the block Hankel matrix;
an LQ decomposition unit to generate a data matrix by combining the block Hankel matrices, and output submatrices of an LQ decomposition of the data matrix;
a parallel projection generator to generate a parallel projection based on the submatrices and the block Hankel matrices;
a singular value decomposition unit to output a first orthogonal matrix, a column vector of which corresponds to a left singular vector of the parallel projection, a second orthogonal matrix, a column vector of which corresponds to a right singular vector of the parallel projection, and a singular value of the parallel projection, based on singular value decomposition of the parallel projection;
a system dimension determination unit to identify a system matrix of a linear discrete-time system describing the dynamic system with respect to each dimension belonging to a designated search range of a system dimension, based on the second orthogonal matrix and the singular value, the input vector and the output vector of the dynamic system, and the search range, and determine a system dimension from a comparison between a system characteristic of the linear discrete-time system calculated based on the system matrix and an actual system characteristic of the dynamic system;
a state vector generator to generate a state vector of the dynamic system based on the second orthogonal matrix and the singular value, and the determined system dimension; and
a system matrix identification unit to identify a system matrix of the linear discrete-time system describing the dynamic system based on the input vector and the output vector of the dynamic system, and the state vector of the dynamic system,
wherein the identified system matrix is outputted as the linear discrete-time system describing the dynamic system.

2. The system identification device according to claim 1, wherein the system dimension determination unit includes, with respect to each dimension belonging to the search range,
a system characteristic estimation unit to calculate a system output obtained when actual input data for identification is applied to the identified linear discrete-time system, and output the system output as a system characteristic of the linear discrete-time system, and
a system dimension estimation unit to determine a minimum dimension from among dimensions at which a norm of a sum of squares of errors in a time domain of the system output of the linear discrete-time system and the actual output data for identification of the dynamic system is less than or equal to a set threshold value, to be a system dimension, and output the system dimension.

3. The system identification device according to claim 1, wherein the system dimension determination unit includes, with respect to each dimension belonging to the search range,
a system characteristic estimation unit to calculate a frequency response of the identified linear discrete-time system, and output the frequency response as a system characteristic of the linear discrete-time system, and
a system dimension estimation unit to determine a minimum dimension from among dimensions at which a norm of a sum of squares of errors in a frequency domain of the frequency response of the linear discrete-time system and an actual frequency response obtained from the system input and output of the dynamic system is less than or equal to a set threshold value, to be a system dimension, and output the system dimension.

4. The system identification device according to claim 3, wherein the system dimension estimation unit
determines a weighting function based on the actual frequency response obtained from the system input and output of the dynamic system,
calculates an addition value that is a value obtained by multiplying the value of squares of errors in the frequency domain of the frequency response of the linear discrete-time system and the actual frequency response of the dynamic system by the weighting function, and
determines a minimum dimension from among dimensions at which a norm of the addition value is less than or equal to a set threshold value to be a system dimension to output the system dimension.

5. The system identification device according to claim 1, wherein the system dimension determination unit includes a recursive system matrix estimation unit to identify, with regard to identification of a system matrix corresponding to a first dimension belonging to the search range, system matrices corresponding to the first dimension through a recursive method, using an identification result of a system matrix associated with a second dimension that is lower than the first dimension by one level in the search range, a right singular vector and a singular value, each of which is associated with a dimension greater than the second dimension and less than or equal to the first dimension, from among the second orthogonal matrix and the singular value, and the input vector and the output vector of the dynamic system.

6. The system identification device according to claim 1, wherein the system input/output extractor sets a value obtained by multiplying a set ratio threshold value by a maximum value of a system input as a system input threshold value, and sets a minimum value of times at which an absolute value of the system input is greater than or equal to the system input threshold value as a pseudorandom input application time, thereby to extract a system input and a system output on or after the pseudorandom input application time as input data for identification and output data for identification, respectively.

7. The system identification device according to claim 1, wherein the system dimension determination unit includes a system stability evaluation unit to evaluate a stability of the linear discrete-time system with respect to each dimension belonging to the search range,
wherein a system dimension is determined from a system characteristic of a linear discrete-time system associated with a dimension at which the system is stable.

8. A system identification method in which system input and output obtained when a pseudorandom input is applied to a dynamic system to be identified is received as an input, the system identification method comprising:
extracting input and output data for identification applied to identification from the system input and output of the dynamic system;
generating block Hankel matrices based on the input and output data for identification;
generating an input vector and an output vector of the dynamic system based on the block Hankel matrix;
generating a data matrix by combining the block Hankel matrices, and outputting submatrices of an LQ decomposition of the data matrix;
generating a parallel projection based on the submatrices and the block Hankel matrices;
outputting a first orthogonal matrix, a column vector of which corresponds to a left singular vector of the parallel projection, a second orthogonal matrix, a column vector of which corresponds to a right singular vector of the parallel projection, and a singular value of the parallel projection, based on singular value decomposition of the parallel projection;
identifying a system matrix of a linear discrete-time system describing the dynamic system with respect to each dimension belonging to a designated search range of a system dimension, based on the second orthogonal matrix and the singular value, the input vector and the output vector of the dynamic system, and the search range, and determining a system dimension from a comparison between a system characteristic of the linear discrete-time system calculated based on the system matrix and an actual system characteristic of the dynamic system;
generating a state vector of the dynamic system based on the second orthogonal matrix and the singular value, and the determined system dimension; and
identifying a system matrix of the linear discrete-time system describing the dynamic system based on the input vector and the output vector of the dynamic system, and the state vector of the dynamic system,
wherein the identified system matrix is outputted as the linear discrete-time system describing the dynamic system.
